(19) United States
(12) Patent Application Publication
(10) Pub. No.: US 2023/0154312 A1
(43) Pub. Date: May 18, 2023

(54) STATE ESTIMATION METHOD, STATE ESTIMATION APPARATUS AND PROGRAM

(71) Applicant: NIPPON TELEGRAPH AND TELEPHONE CORPORATION, Tokyo (JP)

(72) Inventors: Kohei MORI, Tokyo (JP); Takahiro HATA, Tokyo (JP); Yuki YOKOHATA, Tokyo (JP); Aki HAYASHI, Tokyo (JP); Kazuaki OBANA, Tokyo (JP)

(73) Assignee: NIPPON TELEGRAPH AND TELEPHONE CORPORATION, Tokyo (JP)

(21) Appl. No.: 17/919,234

(22) PCT Filed: Apr. 21, 2020
(86) PCT No.: PCT/JP2020/017209

§ 371 Date: Oct. 14, 2022

(51) Int. Cl. G08G 1/01; G08G 1/04; G08G 1/065

(52) U.S. Cl. CPC G08G 1/0112; G08G 1/04; G08G 1/065

(57) ABSTRACT

A state estimation method executed by a state estimation apparatus including a processor and a memory storing program instructions that cause the processor to estimate a state related to congestion on a subject lane, includes acquiring a state related to congestion of a monitoring vehicle traveling on a non-subject lane, counting a number of vehicles traveling on the subject lane, the vehicles being overtaken by the monitoring vehicle or being oncoming vehicles passed by the monitoring vehicle, and estimating the state related to the congestion on the subject lane, using the state related to the congestion of the monitoring vehicle and the number of vehicles. In the estimating, when the number of the vehicles is equal to or greater than a threshold value according to the state related to the congestion of the monitoring vehicle, the state related to the congestion on the subject lane is estimated as traffic congestion.

### TECHNICAL FIELD

The present invention relates to a technique for estimating the level of congestion of vehicles traveling on a road.

### BACKGROUND ART

Examples of the known art related to estimation of the level of congestion of vehicles traveling on a road include techniques described in NPL 1 to NPL 3.

NPL 1 describes a technique for recognizing a circumstance such as traffic congestion, an accident, and a traffic violation by analyzing a video of a surveillance camera installed on a general road, an expressway, and the like.

NPL 2 describes a system for performing traffic volume measurement (a vehicle count and a speed of vehicles) and sudden event sensing determinations (a vehicle stop, a slow speed, traffic congestion, an avoidance travel, and a reverse travel) by utilizing a millimeter wave radar. NPL 3 describes a technique for acquiring traffic volume data by a sensor installed on a roadside.

### CITATION LIST

### Non Patent Literature

NPL 1: https://pr.fujitsu.com/jp/news/2016/10/18-2.html, searched on Apr. 13, 2020, the Internet
NPL 2: https://www.c-nexco-het-tech.jp/detail/0048.php, searched on Apr. 13, 2020; the Internet
NPL 3: http://library.jsce.or.jp/jsce/open/00984/2008/2008-0071.pdf, searched on Apr. 13, 2020, the Internet

### SUMMARY OF THE INVENTION

### Technical Problem

However, in the prior art, information obtained by a camera or a sensor installed at a certain location is used, and thus, it is not possible to understand a wide range or/and a detailed level of congestion on a road. For example, in the prior art, it is possible to know that there is traffic congestion at the point where the camera is installed. However, unless the beginning or the end of the traffic congestion is captured with the camera, it is not possible to comprehend a range of the road where the traffic congestion occurs. In the case of the sensor, it is possible to comprehend a traffic flow in the range sensed by the sensor. However it is not possible to comprehend a traffic flow for each lane (for example, waiting for entry to a parking place of a commercial facility).

The present invention has been made in view of the above-described circumstances, and an object thereof is to provide a technique allowing for estimation of a wide range of a state related to congestion of vehicles traveling on a road.

### Means for Solving the Problem

According to the disclosed technique, the present invention provides a state estimation method executed by a state estimation apparatus for estimating a state related to congestion on a subject lane. The method includes acquiring a state related to congestion of a monitoring vehicle traveling on a non-subject lane, counting a number of vehicles traveling on the subject lane, the vehicles being overtaken by the monitoring vehicle or being oncoming vehicles passed by the monitoring vehicle, and estimating the state related to the congestion on the subject lane, in accordance with the state related to the congestion of the monitoring vehicle and the number of the vehicles. In the estimating, if the number of the vehicles is equal to or greater than a threshold value according to the state related to the congestion of the monitoring vehicle, the state related to the congestion on the subject lane is estimated to be traffic congestion.

### Effects of the Invention

According to the disclosed technique, it is possible to estimate a wide range of a state related to congestion of vehicles traveling on a road.

### BRIEF DESCRIPTION OF DRAWINGS

FIG. 1 is a diagram illustrating a configuration of a congestion-level estimation system according to an embodiment of the present invention.

FIG. 2 is a diagram for explaining an overview of an embodiment of the present invention.

FIG. 3 is a diagram for explaining an overview of an embodiment of the present invention.

FIG. 4 is a diagram for explaining an overview of an embodiment of the present invention.

FIG. 5 is a diagram for explaining an overview of an embodiment of the present invention.

FIG. 6 is a diagram for explaining an overview of an embodiment of the present invention.

FIG. 7 is a diagram for explaining an overview of an embodiment of the present invention.

FIG. 8 is a diagram for explaining an overview of an embodiment of the present invention.

FIG. 9 is a diagram for explaining an overview of an embodiment of the present invention.

FIG. 10 is a diagram for explaining an overview of an embodiment of the present invention.

FIG. 11 is a diagram for explaining an overview of an embodiment of the present invention.

FIG. 12 is a flowchart illustrating an operation of a congestion-level estimation apparatus.

FIG. 13 is a diagram for explaining a specific processing procedure.

FIG. 14 is a diagram for explaining a specific processing procedure.

FIG. 15 is a diagram for explaining a specific processing procedure.

FIG. 16 is a diagram for explaining a specific processing procedure.

FIG. 17 is a diagram for explaining a specific processing procedure.

FIG. 18 is a diagram for explaining a specific processing procedure.

FIG. 19 is a diagram for explaining a specific processing procedure.

FIG. 20 is a diagram for explaining a specific processing procedure.

FIG. 21 is a diagram illustrating an example of congestion level estimation.

FIG. 22 is a diagram illustrating an example of congestion level estimation.

FIG. 23 is a diagram illustrating an example of congestion level estimation.

FIG. 24 is a diagram illustrating an example of traffic congestion caused due to waiting for a traffic light to change.

FIG. 25 is a diagram illustrating an example of traffic congestion caused due to waiting for entry to a parking place.

FIG. 26 is a diagram illustrating an example of traffic congestion caused due to an unknown reason.

FIG. 27 is a diagram illustrating an example of a monitoring vehicle involved in traffic congestion.

FIG. 28 is a diagram illustrating a hardware configuration of the congestion-level estimation apparatus.

### DESCRIPTION OF EMBODIMENTS

Hereinafter, an embodiment of the present invention (the present embodiment) will be described with reference to the drawings. The embodiments to be described below are examples, and embodiments to which the present invention is applied are not limited to the following embodiments.

System Configuration

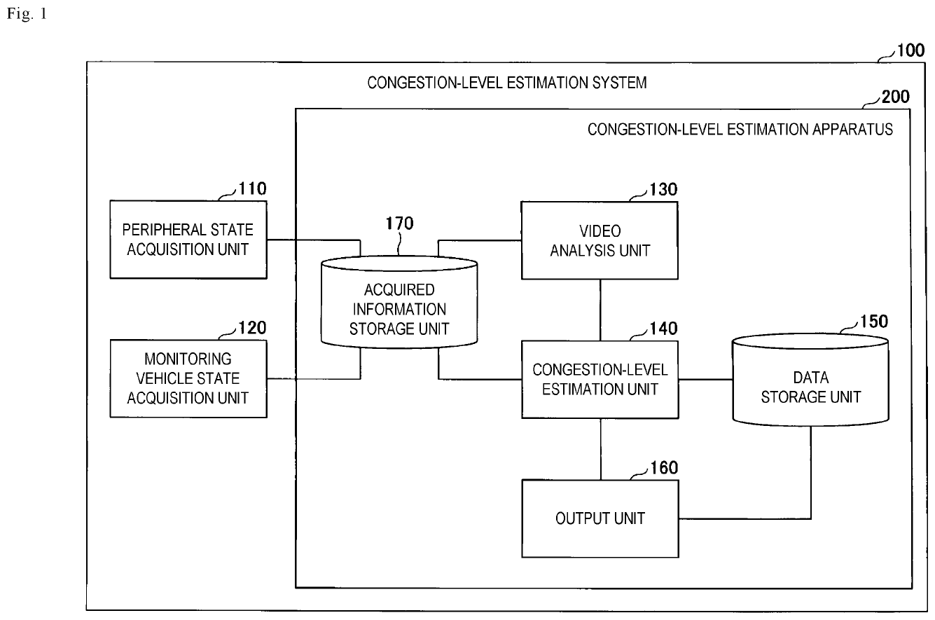

FIG. 1 is a diagram illustrating a configuration of a congestion-level estimation system 100 according to an embodiment of the present invention. As illustrated in FIG. 1, the congestion-level estimation system 100 includes a peripheral state acquisition unit 110, a monitoring vehicle state acquisition unit 120, and a congestion-level estimation apparatus 200. The congestion-level estimation apparatus 200 includes an acquired information storage unit 170, a video analysis unit 130, a congestion-level estimation unit 140, a data storage unit 150, and an output unit 160. Note that the monitoring vehicle state acquisition unit 120 may be referred to as “acquisition unit”, the video analysis unit 130 may be referred to as “count unit”, and the congestion-level estimation unit 140 may be referred to as “estimation unit”. The congestion-level estimation apparatus 200 may be referred to as “state estimation apparatus”.

In the present embodiment, a vehicle (such as an automobile, a truck, a bus, a bike, an agricultural equipment, and a bicycle) traveling on a certain lane on a road is mounted with the congestion-level estimation system 100.

Alternatively, the vehicle is mounted with the peripheral state acquisition unit 110 and the monitoring vehicle state acquisition unit 120, and the congestion-level estimation apparatus 200 may be provided at a location other than in the vehicle. In this case, for example, the peripheral state acquisition unit 110 and the monitoring vehicle state acquisition unit 120 are each connected to the congestion-level estimation apparatus 200 via a communication network.

Hereinafter, the vehicle mounted with the peripheral state acquisition unit 110 and the monitoring vehicle state acquisition unit 120 (including a vehicle mounted with the congestion-level estimation system 100) is referred as to “monitoring vehicle”. A vehicle other than the “monitoring vehicle” is simply referred to as “vehicle”.

In the present embodiment, based on information on a peripheral state acquired by the peripheral state acquisition unit 110 mounted in the monitoring vehicle traveling on a certain lane on a road and information on a state related to congestion of the monitoring vehicle (which may also be referred to as “host vehicle”) acquired by the monitoring vehicle state acquisition unit 120 mounted in the monitoring vehicle, the congestion-level estimation apparatus 200 estimates the level of congestion of vehicles on the certain lane on the road. In other words, the level of congestion of vehicles may be referred to as “state related to congestion” of vehicles. The “level of congestion of vehicles” may be merely referred to as “level of congestion”.

The congestion-level estimation apparatus 200, mainly estimates the level of congestion on a lane other than the lane on which the monitoring vehicle travels. Thus, a lane other than the lane on which the monitoring vehicle travels is referred to as “subject lane”, and the lane on which the monitoring vehicle travels is referred to as “monitoring lane”. The “monitoring lane” may be referred to as “non-subject lane”. Note that, as described below, the congestion-level estimation apparatus 200 is also capable of estimating the level of congestion on the monitoring lane. The “subject lane” and the “monitoring lane” may not be adjacent. The “subject lane” may include a plurality of lanes.

In a basic operation, the congestion-level estimation apparatus 200 directly estimates the level of congestion of the subject lane, based on a speed of the monitoring vehicle, and the number of vehicles (vehicle count) overtaken (passed) by or overtaking (passing) the monitoring vehicle per unit time period on the subject lane. Note that using the monitoring vehicle on the subject lane as a reference, it is stated that the monitoring vehicle overtakes a vehicle if the vehicle whose relative position moves from the front to the back is sensed and that the monitoring vehicle is overtaken by a vehicle if the vehicle whose relative position moves from the back to the front is sensed.

The peripheral state acquisition unit 110 and the monitoring vehicle state acquisition unit 120 will be described below. Detailed operations of each component included in the congestion-level estimation apparatus 200 will be described later.

The congestion-level estimation apparatus 200 counts the number of vehicles overtaken by the monitoring vehicle on the subject lane, the number of vehicles overtaking the monitoring vehicle on the subject lane, and/or the number of oncoming vehicles passed by the monitoring vehicle on a lane opposite to the monitoring lane, based on the information on the peripheral state acquired by the peripheral state acquisition unit 110. The oncoming vehicle passed by the monitoring vehicle means that a vehicle traveling on a lane opposite to the monitoring lane senses a vehicle whose relative position moves from the front to the back, relative to the monitoring vehicle.

The peripheral state acquisition unit 110 is, for example, a camera (a vehicle-mounted camera, a camera on a smart phone, an infrared camera, and the like). In this case, the information on the peripheral state is video of a peripheral area of the monitoring vehicle.

Note that the peripheral state acquisition unit 110 is not limited to a camera, and the peripheral state acquisition unit 110 may be any means capable of acquiring the information on the peripheral state and capable of counting the number of vehicles and the like overtaken by the monitoring vehicle.

For example, the peripheral state acquisition unit 110 may be a sensor such as a light detection and ranging (LiDAR). In the LiDAR, a target object is irradiated and scanned with a laser light beam to observe the resultant scattering and reflected light to measure a distance to the target object, allowing for evaluation of a shape of the target object and a relative position of the target object relative to the monitoring vehicle. The congestion-level estimation apparatus 200 can use the evaluated information to identify a vehicle and the like overtaken by the monitoring vehicle.

The monitoring vehicle state acquisition unit 120 acquires a speed of the monitoring vehicle and location information of the monitoring vehicle. The monitoring vehicle state acquisition unit 120 includes, for example, a GPS receiver to acquire the location information of the monitoring vehicle.

A function unit that acquires the speed of the monitoring vehicle in the monitoring vehicle state acquisition unit 120 may be a functional unit that acquires information of a speedometer mounted in the monitoring vehicle, may be a function unit that acquires speed information measured by a car navigation system or a drive recorder mounted in the monitoring vehicle, may be a function unit that measures a speed from acceleration information obtained from an on-board sensor, a smartphone, and the like, and may be a function unit that measures a speed from a temporal change of location information obtained from the GPS receiver, for example.

Note that the speed of the monitoring vehicle acquired by the monitoring vehicle state acquisition unit 120 is an example of the level of congestion (state related to congestion) of the monitoring vehicle. As the speed of the monitoring vehicle decreases, the state related to the congestion of the monitoring vehicle is estimated to be traffic congestion, and as the speed of the monitoring vehicle increases, the state related to the congestion of the monitoring vehicle is estimated to be non-traffic congestion.

The monitoring vehicle state acquisition unit 120 may acquire information other than the speed of the monitoring vehicle as the information on the state related to the congestion. For example, the monitoring vehicle state acquisition unit 120 may measure a distance between a vehicle ahead of the monitoring vehicle and the monitoring vehicle by using a sensor, and may acquire, based on the distance, the information on the state related to the congestion on the monitoring lane on which the monitoring vehicle travels.

In the following description, in one example, the peripheral state acquisition unit 110 is a camera mounted in the monitoring vehicle, and the monitoring vehicle state acquisition unit 120 acquires the speed of the monitoring vehicle, as the information on the state related to the congestion on the monitoring lane on which the monitoring vehicle travels.

Note that in the following description, an example is provided in which the camera captures an area in a front direction of the monitoring vehicle, but that a direction that the camera does not necessarily capture the area in the front direction. For example, the camera may capture an area in a back direction of the monitoring vehicle.

Outline of Congestion Level Estimation

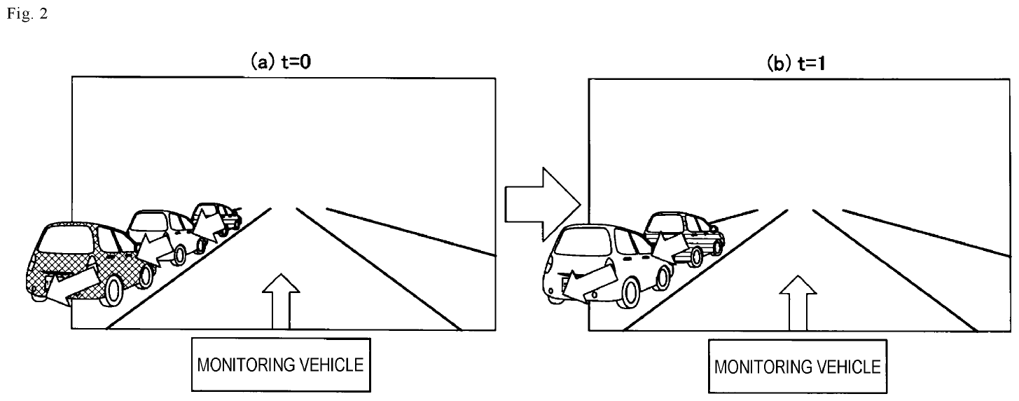

An outline of congestion-level estimation processing executed by the congestion-level estimation apparatus 200 will be described. Basically, in the present embodiment, the congestion-level estimation apparatus 200 estimates the level of congestion on the subject lane, using the speed of the monitoring vehicle traveling on the monitoring lane, and the number of vehicles traveling on the subject lane overtaken by the monitoring vehicle (or overtaking the monitoring vehicle or passed by the monitoring vehicle). With reference to FIGS. 2 to 11, an outline of the congestion level estimation in various examples will be described.

### Example 1

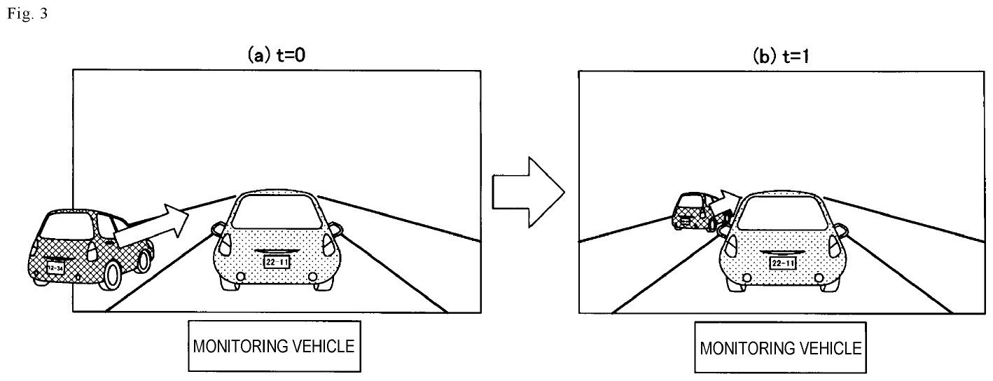

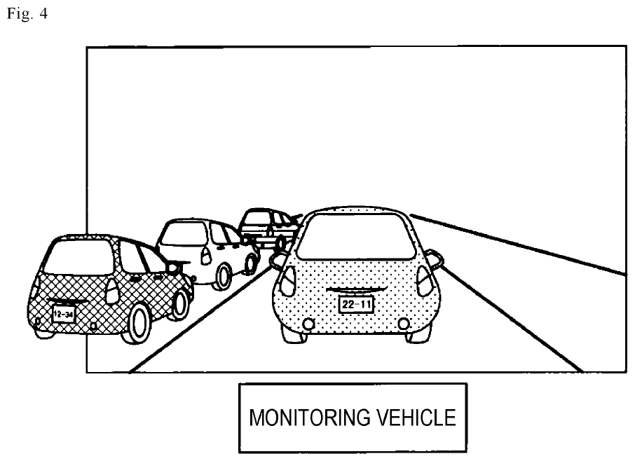

Example 1 will be described with reference to FIG. 2. FIG. 2 (and FIGS. 3 and 4) illustrates an example of a case where on a road having three lanes (each referred to as “left lane”, “center lane”, and “right lane”) on one side, the monitoring vehicle travels on the center lane.

In Example 1, the left lane (defined as the subject lane) has a high level of congestion of vehicles, that is, traffic congestion, and each vehicle travels at a low speed V1. The center lane has a low level of congestion, vehicles flow smoothly, and the monitoring vehicle travels at a speed V2 (>V1).

FIG. 2(a) illustrates an image of video captured by the peripheral state acquisition unit 110 (hereinafter, “camera”) mounted in the monitoring vehicle at t (time)=0, and FIG. 2(b) illustrates an image of video captured by the camera mounted in the monitoring vehicle at t=1. Hereinbelow, the same applies to drawings similar to FIGS. 2(a) and 2(b).

Note that in each of the drawings, an arrow line provided at a lower part of the center lane indicates the speed of the monitoring vehicle and an arrow line added to the vehicle on the subject lane indicates a speed (a direction and a velocity) at which the vehicle flows on the video captured by the camera mounted in the monitoring vehicle. It is obvious that the speed indicated by each arrow line is approximated.

Under a circumstance of FIG. 2, a vehicle on the left lane with traffic congestion is overtaken by the monitoring vehicle on the center lane with smooth flow, and thus, as illustrated in (t=0) in FIG. 2(a) and (t=1) in FIG. 2(b), the vehicle on the left lane (subject lane) flows backward on the video captured by the camera of the monitoring vehicle. If the speed of the monitoring vehicle is constant, as the level of congestion on the left lane (subject lane) increases, the number of vehicles on the left lane (subject lane) flowing backward per unit time period increases.

Based on the above event, in the present embodiment, the congestion-level estimation apparatus 200 analyzes the video captured by the camera of the monitoring vehicle to count the number of vehicles on the subject lane overtaken by the monitoring vehicle per unit time period, and if the speed of the monitoring vehicle is constant, the congestion-level estimation apparatus 200 determines that as the number of vehicles overtaken by the monitoring vehicle increases, the level of congestion on the subject lane increases. In other words, “the level of congestion is high” may mean “there is traffic congestion”.

### Example 2

Example 2 will be described with reference to FIG. 3. In Example 2, on the left lane (subject lane), vehicles flow smoothly, and each vehicle travels at a speed V3. The center lane has a high level of congestion, that is, traffic congestion, and vehicles on the center lane, including the monitoring vehicle, travel at a low speed V4 (<V3) or stop.

Under a circumstance of FIG. 3, the monitoring vehicle on the center lane with traffic congestion is overtaken by a vehicle on the left lane with smooth flow, and thus, as illustrated in (t=0) in FIG. 3(a) and (t=1) in FIG. 3(b), the vehicle on the left lane (subject lane) flows forward on the video captured by the camera of the monitoring vehicle. Note that the number of vehicles overtaking the monitoring vehicle may mean how many minus vehicles the monitoring vehicle has overtaken.

According to the above event, the congestion-level estimation apparatus 200 analyzes the video captured by the camera of the monitoring vehicle to count the number of vehicles on the left lane (subject lane) overtaking the monitoring vehicle per unit time period, and may determine that the level of congestion on the left lane (subject lane) is low because the number of vehicles overtaking the monitoring vehicle is large.

The congestion-level estimation apparatus 200 may determine that the level of congestion on the center lane (monitoring lane) is high when the speed of the monitoring vehicle is low and the number of vehicles overtaking the monitoring vehicle is large. Thus, in the present embodiment, based on the speed of the monitoring vehicle and the video captured by the camera, it is possible to estimate the levels of congestion not only on the subject lane but also on the monitoring lane.

### Example 3

Example 3 will be described with reference to FIG. 4. In Example 3, both the levels of congestion on the left lane (subject lane) and on the center lane (monitoring lane) are high, and the vehicles on both the lanes travel at a low speed or stop.

Under this circumstance, in the video captured by the camera of the monitoring vehicle, a change in chronological order is small, and the flow of the vehicles (overtaking/being overtaken) on the video as illustrated in Examples 1 and 2 does not occur. In this case, the congestion-level estimation apparatus 200 counts, from the video, both the number of vehicles overtaking the monitoring vehicle and the number of vehicles overtaken by the monitoring vehicle as zero, but may determine that the level of congestion on the left lane (subject lane) is high by detecting that there are a plurality of vehicles on the left lane (subject lane).

### Example 4

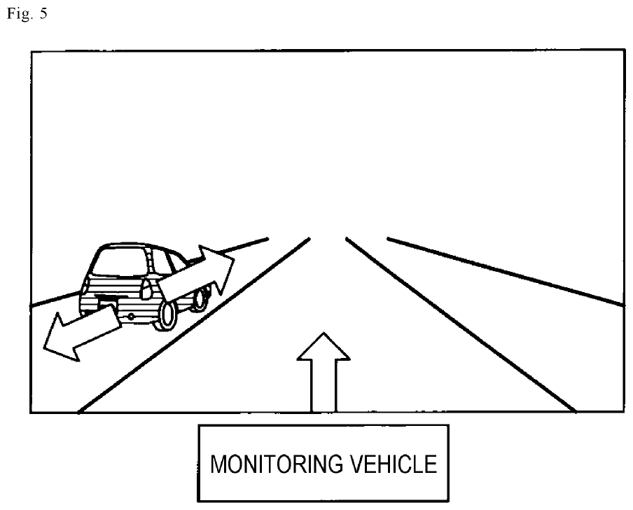

Example 4 will be described with reference to FIG. 5. In Example 4, both the levels of congestion on the left lane (subject lane) and the center lane (monitoring lane) are low, and vehicles travels smoothly on both the lanes.

Under this circumstance, depending on a difference in speed between the monitoring vehicle and the vehicle on the left lane (subject lane), in the video captured by the camera of the monitoring vehicle, the vehicle on the left lane (subject lane) may flow forward or backward. Under this circumstance, for example, in sensing that the speed of the monitoring vehicle is equal to or greater than a predetermined threshold value, and both the number of vehicles overtaken by the monitoring vehicle per unit time period and the number of vehicles overtaking the monitoring vehicle per unit time period are equal to or less than a predetermined threshold value, the congestion-level estimation apparatus 200 may determine that both the levels of congestion on the left lane (subject lane) and on the center lane (monitoring lane) are low.

### Example 5

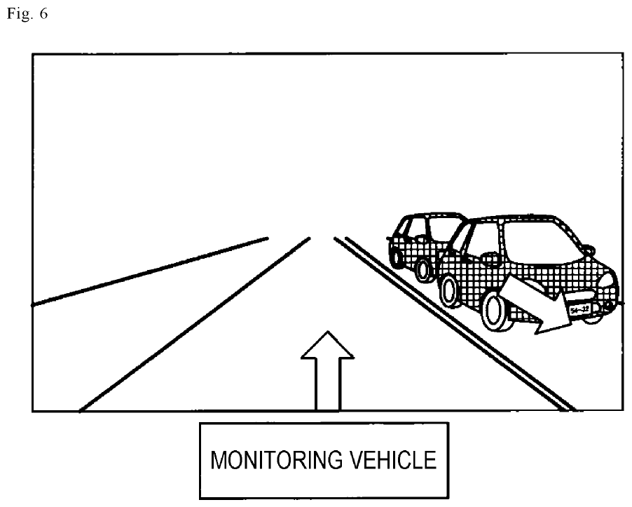

Example 5 will be described with reference to FIG. 6. Example 5 is an example of a case where the subject lane is a lane opposite to the monitoring lane (opposite lane). In Example 5, the level of congestion on the monitoring lane is low, and the monitoring vehicle smoothly travels. On the other hand, the level of congestion on the opposite lane is high, and vehicles on the opposite lane travel at a low speed. Under a circumstance of FIG. 6, on the video captured by the camera of the monitoring vehicle, the vehicle on the right lane (subject lane) flows frontward. Note that the opposite lane refers to a lane on which a vehicle advances in a direction opposite to a direction in which the monitoring vehicle advances. The lane may be defined by a rule such as a law or may be a lane based on a habit commonly used by users of a road to which the lane belongs.

According to the above-described event, the congestion-level estimation apparatus 200 may analyze the video captured by the camera of the monitoring vehicle to count the number of oncoming vehicles on the opposite lane (subject lane) passed by the monitoring vehicle per unit time period, and may determine that the level of congestion on the opposite lane (subject lane) is high if the number of oncoming vehicles passed by the monitoring vehicle is large. Note that when the invention described in Example 5 is applied, it is possible to solve a problem that it is not possible to sense a vehicle reversely traveling on the opposite lane (traveling toward the same direction as the monitoring vehicle) in a region with neither camera nor sensor being installed so that it is not possible to comprehend a reversely traveling vehicle in real time or detailed location information of the reversely traveling vehicle. Specifically, in a case where a traveling speed of the monitoring vehicle is equal to or greater than zero, when counting that the monitoring vehicle is overtaken by a vehicle traveling on the opposite lane, the congestion-level estimation apparatus 200 may determine that a reversely traveling vehicle exists.

### Example 6

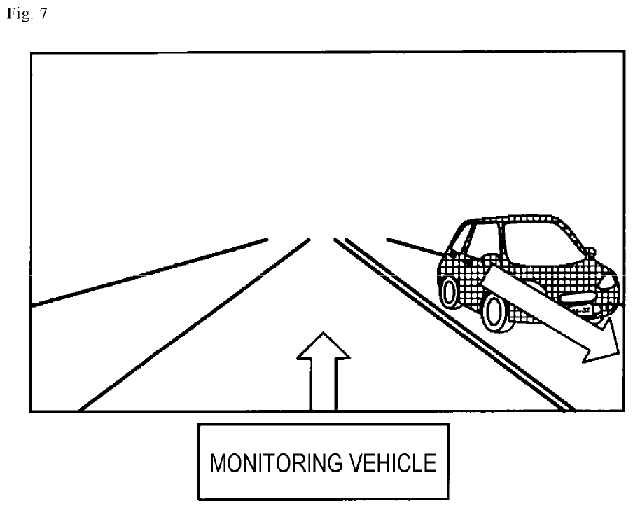

Example 6 will be described with reference to FIG. 7. Similarly to Example 5, Example 6 is an example of a case where the subject lane is a lane opposite to (opposite lane of) the monitoring lane. In Example 6, the levels of congestion both on the monitoring lane and on the opposite lane (subject lane) are low and both the monitoring vehicle and the vehicles on the opposite lane (subject lane) travel smoothly.

Under a circumstance of FIG. 7, on the video captured by the camera of the monitoring vehicle, the vehicle on the opposite lane (subject lane) travels in the direction toward the monitoring vehicle. However, compared to the case of Example 5 (FIG. 6), an interval between the vehicles traveling on the opposite lane (subject lane) is wider.

According to the above-described event, the congestion-level estimation apparatus 200 may analyze the video captured by the camera of the monitoring vehicle to count the number of oncoming vehicles on the opposite lane (subject lane) passed by the monitoring vehicle per unit time period, and may determine that the level of congestion on the opposite lane (subject lane) is low because the number of oncoming vehicles passed by the monitoring vehicle is small.

### Example 7

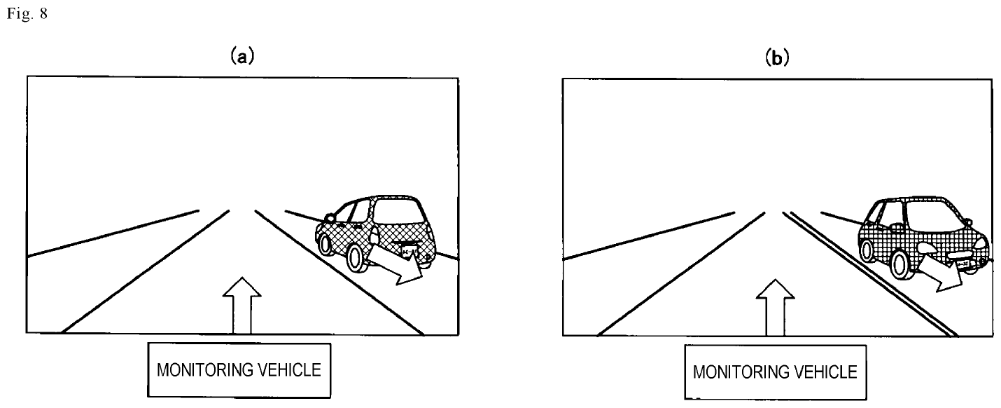

Example 7 will be described with reference to FIG. 8. FIG. 8(a) illustrates video of a road having three lanes on one side. The monitoring vehicle is traveling smoothly on the center lane (monitoring lane), and the right lane (subject lane) has a high level of congestion.

FIG. 8(b) illustrates an example of a case where the subject lane is a lane opposite to the monitoring lane (opposite lane) and illustrates video where the monitoring vehicle travels smoothly.

In this case, even in any of the videos in FIGS. 8(a) and 8(b), based only on a count value of passing vehicles on the subject lane, it is not possible to distinguish a state where the monitoring vehicle overtakes a vehicle on the subject lane from a state where the monitoring vehicle is passed by an oncoming vehicle on the subject lane. Thus, in the present embodiment, the congestion-level estimation apparatus 200 determines whether the subject lane is a lane in the same direction as a lane on which the monitoring vehicle travels or a lane opposite to a lane on which the monitoring vehicle travels, using location information and map information of the monitoring vehicle. Furthermore, the congestion-level estimation apparatus 200 may determine whether the subject lane is a lane in the same direction as a lane on which the monitoring vehicle travels or a lane opposite to a lane on which the monitoring vehicle travels, based on whether a tail lamp of a vehicle on the subject lane is visible on the video.

If it is possible to determine whether the subject lane is a lane in the same direction as a lane on which the monitoring vehicle travels or a lane opposite to a lane on which the monitoring vehicle travels, it is possible to distinguish a state where the monitoring vehicle overtakes a vehicle on the subject lane from a state where the monitoring vehicle is passed by an oncoming vehicle on the subject lane.

Thus, Examples 1 to 7 are described.

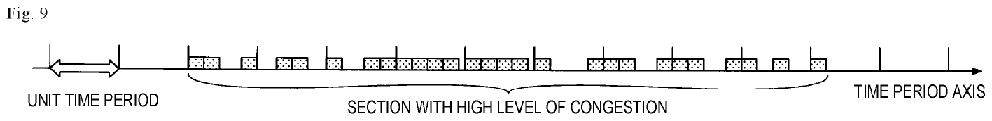

FIG. 9 illustrates an image representing, on a time period axis, the number of vehicles overtaken by the monitoring vehicle on the subject lane, under a circumstance as illustrated in Example 1 of FIG. 2, for example. In determining from the result of a video analysis that the monitoring vehicle overtakes at least N vehicles on the subject lane in a unit time period when the monitoring vehicle travels at a certain speed V, for example, the congestion-level estimation apparatus 200 may estimate that the level of congestion is high (“traffic congestion occurs”) in a section where the monitoring vehicle is traveling at a time in the unit time period. FIG. 9 illustrates an example in which there are continuous unit time periods determined that the traffic congestion occurs, and during a period having the continuous unit time periods, it is possible to estimate that the level of congestion is high. The V and N values can be determined by experimentation or the like in which a vehicle passes beside a subject lane already estimated to be congested.

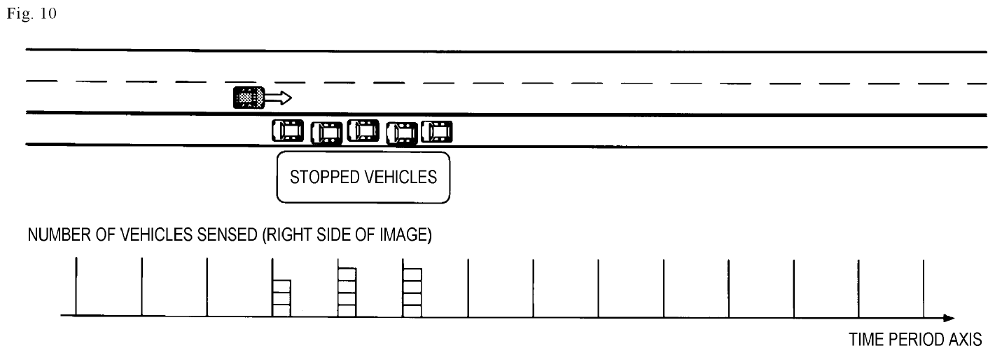

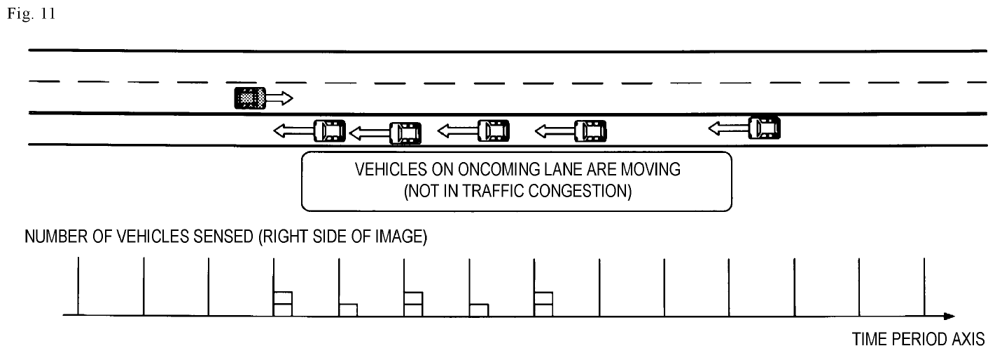

FIG. 10 illustrates an image in a case where the monitoring vehicle counts the number of the oncoming vehicles on the opposite lane (subject lane) passed by the monitoring vehicle (in this case, the oncoming vehicles stop), for example, in the circumstance as illustrated in Example 5 of FIG. 6. FIG. 11 illustrates an image in a case where the monitoring vehicle counts the oncoming vehicles on the opposite lane (subject lane) passed by the monitoring vehicle (in this case, the oncoming vehicles travel smoothly), for example, in the circumstance as illustrated in Example 6 of FIG. 7.

Example of Operation of Congestion-Level Estimation System

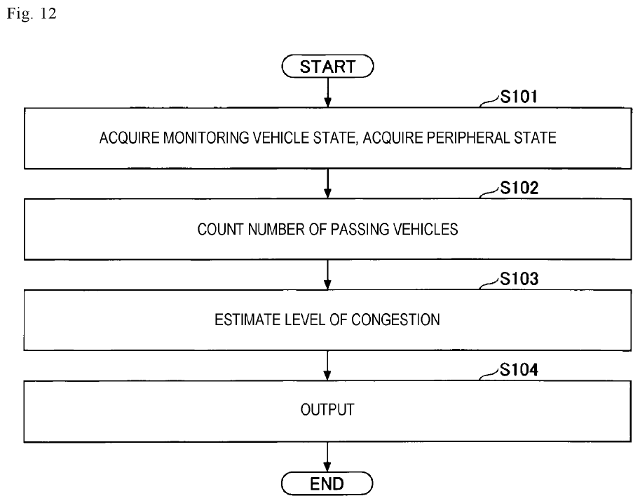

FIG. 12 is a flowchart illustrating an example of an operation of the congestion-level estimation system 100 according to the embodiment. The example of the operation of the congestion-level estimation system 100 will be described below in detail following the order of the flowchart illustrated in FIG. 12.

Note that the congestion-level estimation processing according to the present embodiment may be executed in real time in parallel with traveling of the monitoring vehicle, or peripheral state information and monitoring vehicle state information acquired when the monitoring vehicle travels may be previously stored in a storage device (the acquired information storage unit 170 and the like), and thereafter, the peripheral state information and the monitoring vehicle state information stored in the storage device may be read for execution of the congestion-level estimation processing.

Of the peripheral state acquisition unit 110, the monitoring vehicle state acquisition unit 120, and the congestion-level estimation apparatus 200 included in the congestion-level estimation system 100, the peripheral state acquisition unit 110 and the monitoring vehicle state acquisition unit 120 are mounted in the monitoring vehicle. The congestion-level estimation apparatus 200 may be mounted in the monitoring vehicle, and provided at a location other than the monitoring vehicle. A virtual machine corresponding to the congestion-level estimation apparatus 200 may also be provided over the cloud.

S101: Acquire Monitoring Vehicle State and Acquire Peripheral State

In S101, the peripheral state acquisition unit 110 mounted in the monitoring vehicle traveling on the monitoring lane acquires information on a peripheral state of the monitoring vehicle, and the monitoring vehicle state acquisition unit 120 mounted in the monitoring vehicle traveling on the monitoring lane acquires information on the vehicle state of the monitoring vehicle.

More specifically, the peripheral state acquisition unit 110 is a camera, and the information on the peripheral state of the monitoring vehicle is video captured by the camera. The monitoring vehicle state acquisition unit 120 acquires both the location information of the monitoring vehicle and the speed of the monitoring vehicle. It is assumed that both the information acquired by the peripheral state acquisition unit 110 and the monitoring vehicle state acquisition unit 120 are timestamped with an indication of a time (absolute time) at which the information has been acquired. This allows for synchronization with the video (each frame) of the camera, the speed, and the location information.

The information acquired by the peripheral state acquisition unit 110 and the information acquired by the monitoring vehicle state acquisition unit 120 are transmitted to the congestion-level estimation apparatus 200, and stored in the acquired information storage unit 170 in the congestion-level estimation apparatus 200.

S102: Count Number of Passing Vehicles

In S102, the video analysis unit 130 in the congestion-level estimation apparatus 200 reads the video from the acquired information storage unit 170 and analyzes the read video, so that the number of vehicles on the subject lane overtaken by the monitoring vehicle is counted, for example. More specifically, the following processing is executed. As described in detail below, it is possible to determine on the video whether the monitoring vehicle overtakes a vehicle, based on whether the vehicle passes a predetermined position (passing determination line, for example), and thus, S102 is processing of “counting the number of passing vehicles”.

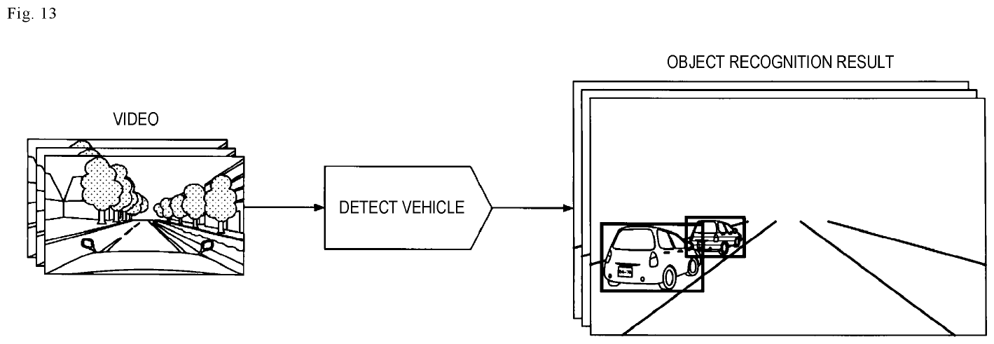

FIG. 13 illustrates an overview of processing before the number of passing vehicles is counted. After reading the video from the acquired information storage unit 170, the video analysis unit 130 detects a vehicle from an image of each frame (referred to as “frame image”) of the video. Processing of detecting a vehicle from an image may be performed by using a well-known object recognition technique.

In detecting the vehicle from the frame image, the video analysis unit 130 determines coordinates (upper left XY coordinates and lower right XY coordinates) corresponding to a rectangle surrounding the vehicle, and stores the image of the vehicle and the coordinates of the rectangle, as an object recognition result, into the data storage unit 150. On the right side of FIG. 13, the image of the vehicle and the rectangle in the frame image are illustrated. Note that the vehicle in a small rectangle, that is, the vehicle at a far distance, is not tracked. For example, the vehicle in a rectangle less than 0.5% the frame image area may not be tracked. For example, a vehicle traveling out of a road and a vehicle traveling on an intersecting road are not also tracked by, for example, narrowing a region on the image.

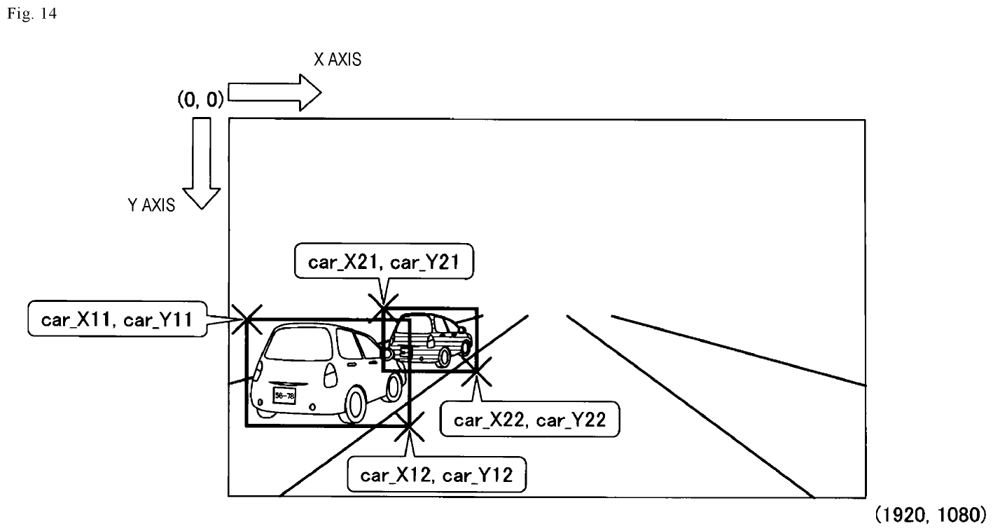

FIG. 14 is a diagram illustrating the image of the vehicle and the rectangle in one frame image in more detail. As illustrated in FIG. 14, a rectangle surrounding a vehicle illustrated on a near side of a frame screen is represented by upper left XY coordinates=(car_X11, car_Y11) and lower right XY coordinates=(car_X12, car_Y12), and a rectangle surrounding a vehicle seen on a far side of the vehicle on the near side is represented by upper left XY coordinates=(car_X21, car_Y21) and lower right XY coordinates=(car_X22, car_Y22). For each frame forming the video (or for each N (N>2) frames), information corresponding to contents illustrated in FIG. 14 (information on the image of the vehicle and the rectangle surrounding the vehicle) is obtained. As each frame arranged in chronological order progresses, the vehicle on the frame image moves on the frame image.

The video analysis unit 130 tracks movement of each vehicle on the frame image (image of 1920×1080 in the example of FIG. 14) captured by the camera, based on the above information on each frame arranged in chronological order.

In one example, the video analysis unit 130 detects a license plate within each rectangle in each frame image, and identifies the vehicle by confirming a number described on the license plate by character recognition. The video analysis unit 130 tracks the movement of the identified vehicle by searching for the rectangle including the number on each frame image.

A method for tracking a vehicle is not limited to a method using the license plate. For example, the video analysis unit 130 may track the vehicle by calculating a characteristic point from within the rectangle and selecting, as a vehicle to be tracked, a vehicle (rectangle) having a characteristic point with a least spatial displacement in characteristic point between the frame images. Such a method and the aforementioned method using a license plate may be combined for use.

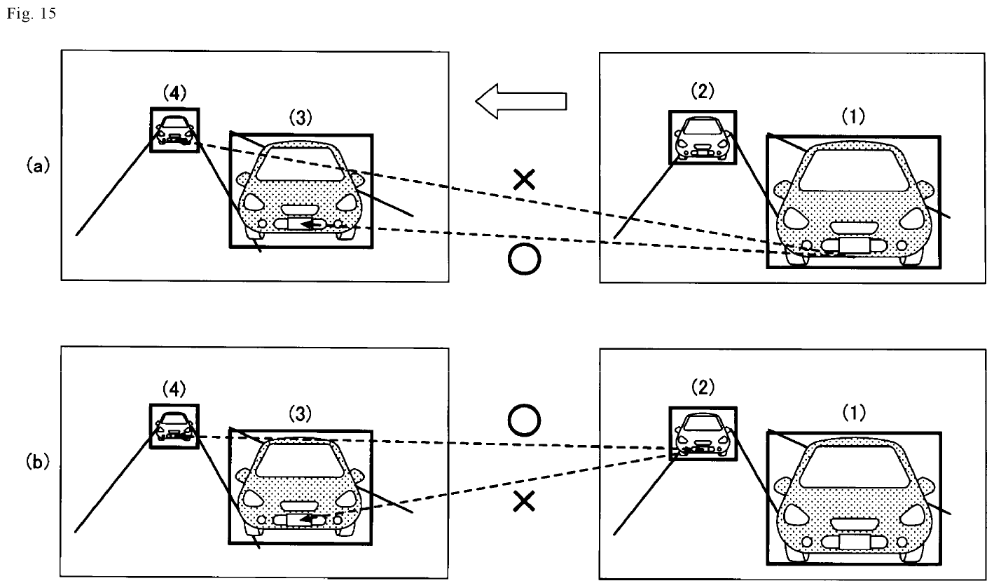

FIG. 15 is a diagram illustrating an example of a combination with a small spatial displacement in characteristic point between the frame images. In each of the upper side (a) and the lower side (b) of FIG. 15, it is assumed that transition from a right-side image to a left-side image is made.

As illustrated in the upper side (a) of FIG. 15, as the left-side image with a characteristic point matching a characteristic point in the rectangle (1), there are the image in the rectangle (3) and the image in the rectangle (4). As indicated by “0” and “x” in the upper side (a) of FIG. 15, the spatial displacement from the characteristic point in the rectangle (1) to the characteristic point in the rectangle (3) is smaller than the spatial displacement from the characteristic point in the rectangle (1) to the characteristic point in the rectangle (4) in the frame image, and thus, it is possible to determine that the vehicle to be tracked in the rectangle (1) is the vehicle in the rectangle (3).

As illustrated in the lower side (b) of FIG. 15, as the left-side image with a characteristic point matching a characteristic point in the rectangle (2), there are the image in the rectangle (4) and the image in the rectangle (3). As indicated by “0” and “x” in the lower side (b) of FIG. 15, the spatial displacement from the characteristic point in the rectangle (2) to the characteristic point in the rectangle (4) is smaller than the spatial displacement from the characteristic point in the rectangle (2) to the characteristic point in the rectangle (3) in the frame image, and thus, it is possible to determine that the vehicle to be tracked in the rectangle (2) is the vehicle in the rectangle (4).

Next, the video analysis unit 130 determines for each identified vehicle whether the identified vehicle passes a specified part (predetermined position) on the frame image, determines a passing direction if the identified vehicle passes the specified part, and counts the number of passing times.

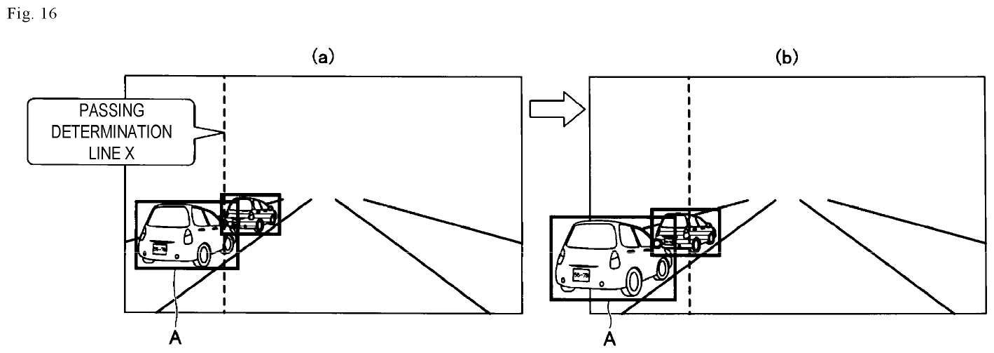

A specific example will be described with reference to FIG. 16. In FIG. 16, it is assumed that transition from a frame image in (a) to a frame image in (b) is made. As illustrated in FIGS. 16(a) and (b), in the present embodiment, a passing determination line is provided at a previously determined position on the frame image. FIG. 16 illustrates an example with a target (subject lane) being a lane on the left side of the monitoring lane on which the monitoring vehicle travels, and thus, illustrates a passing determination line in a vertical direction provided on the left side from a center in a horizontal width direction of the frame image.

The video analysis unit 130 counts the number of rectangles of which the edge (in this example, the target is the left lane, and thus, the edge of the rectangle is a right edge) passes the passing determination line on the frame image, for example. When the number is counted, the passing direction is also reflected.

In the example of FIG. 16, when transition from (a) to (b) is made, a right edge of a rectangle A, that is, one of the rectangles for the vehicle identified for tracking, passes from the right to the left of the passing determination line. This passing direction corresponds to a direction in which the monitoring vehicle overtakes such a vehicle. Thus, a part of the rectangle to be focused passing from the right to the left of the passing determination line may be expressed as “a vehicle passing from the right to the left of the passing determination line”. Furthermore, a part of the rectangle to be focused passing from the right to the left of the passing determination line may be expressed as “a monitoring vehicle overtaking a vehicle on the subject lane”.

In the present embodiment, in a case where the subject lane is a lane on the left side of the monitoring lane, as in FIG. 16, if it is detected that the right edge of the rectangle passes the passing determination line from the right to the left, the video analysis unit 130 records “−1” meaning that the monitoring vehicle overtakes one vehicle in a storage means such as a memory. A count value “1” and information indicating a direction may be recorded separately. Note that the count value “−1” in the case of overtaking one vehicle is a mere example. If the monitoring vehicle overtakes one vehicle, the count value may be “1”, and if the monitoring vehicle is overtaken, the count value may be “−1”.

A vehicle type (a small vehicle, a standard vehicle, and a large vehicle such as a bus) of a vehicle may be identified from the image, and, for example, the large vehicle may be counted as two small vehicles/standard vehicles. That is, in the above example, “−2” may be recorded.

In a case where the subject lane is a lane on the right side of the monitoring lane, if the monitoring vehicle overtakes a vehicle on the subject lane, the end of the corresponding rectangle passes the passing determination line provided for the lane on the right side from the left to the right on the frame image. Thus, in a case where the subject lane is a lane on the right side of the monitoring lane, if it is detected that the edge of the rectangle passes the passing determination line from the left to the right, the video analysis unit 130 records “−1” meaning that the monitoring vehicle overtakes one vehicle.

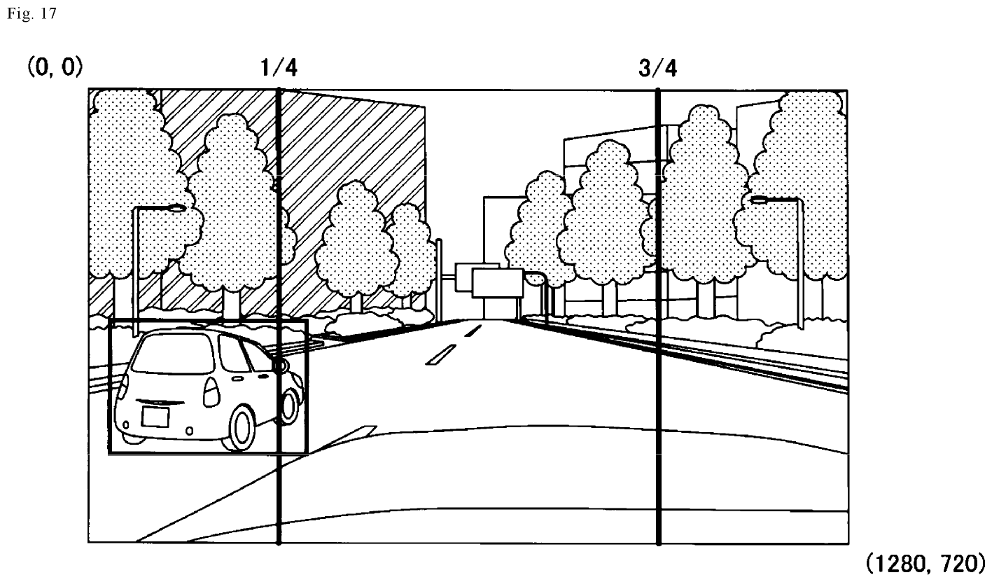

FIG. 17 is a diagram illustrating an example of the passing determination line in a case where both a lane on the left side and a lane on the right side of the monitoring lane are reflected. In an example of FIG. 17, as a passing determination line with the lane on the left side being reflected, one passing determination property is provided at a position of ¼ the length of the horizontal width (that is, X=320) from the left (X=0) of the frame image, and as a passing determination line with the lane on the right side being reflected, one passing determination line is provided at a position of ¾ the length of the horizontal width (that is, X=960) from the left (X=0) of the frame image. Note that ¼ or ¾ is a mere example.

For example, as a passing determination line with the lane on the left side being reflected, one passing determination property may be provided at a position of 1.5/5 the length of the horizontal width from the left (X=0) of the frame image, and as a passing determination line with the lane on the right side being reflected, one passing determination property may be provided at a position of 3.5/5 the length of the horizontal width from the left (X=0) of the frame image.

Moreover, the passing determination line is not limited to a vertical line as illustrated in FIGS. 16 and 17. For example, the passing determination line may be a diagonal line.

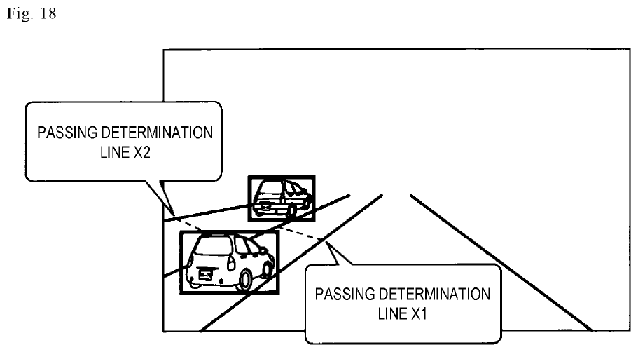

In consideration of a case where there are a plurality of lanes either on the left side or on the right side, the number of passing times may be counted separately by providing a plurality of passing determination lines so as to count the number of passing times for each lane. FIG. 18 illustrates an example of a case where there are two diagonal passing determination lines. For example, in a passing determination line X1 of FIG. 18, the number of passing times may be counted by determining whether specific coordinates such as a center point of a side of the right edge of the rectangle pass the passing determination line X1.

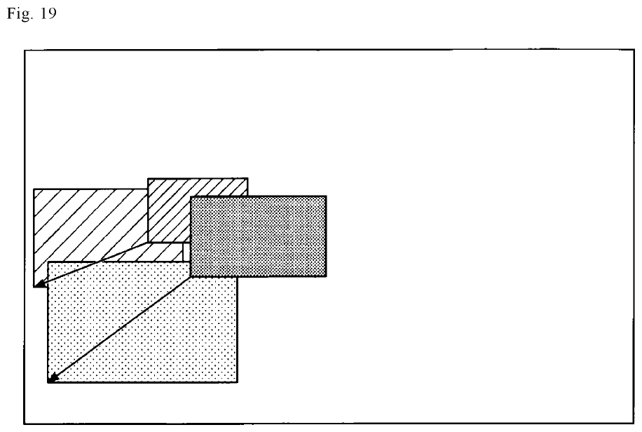

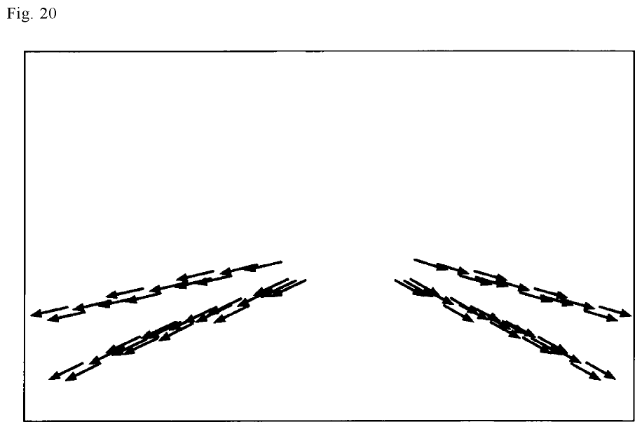

In the individual lanes in the plurality of lanes, for example, as illustrated in FIG. 19, in a case of the left lane, it is possible to determine the lanes by a trajectory (inclination of a vector) of coordinates of a lower left corner of the rectangle. FIG. 19 illustrates an example of the plurality of lanes on the left side, and even in a case of the individual lanes in a plurality of lanes on the right side, it is possible to determine the lanes by a trajectory (inclination of a vector) of coordinates of a lower right corner of the rectangle. FIG. 20 illustrates an example of a trajectory of coordinates of the rectangle in a case where there are a plurality of lanes on each of the right side and the left side. As illustrated in FIG. 20, it is possible to determine the lanes by the trajectory.

The determination examples based on the passing determination line are summarized as follows.

On the lane on the left side of the monitoring lane, the vehicle passing the passing determination line from the right to the left corresponds to the monitoring vehicle overtaking the vehicle on the lane on the left side.

On the lane on the left side of the monitoring lane, the vehicle passing the passing determination line from the left to the right corresponds to the monitoring vehicle being overtaken by the vehicle on the lane on the left side.

On the lane on the right side (not the opposite lane) of the monitoring lane, the vehicle passing the passing determination line from the left to the right corresponds to the monitoring vehicle overtaking the vehicle on the lane on the right side.

On the lane on the right side (not the opposite lane) of the monitoring lane, the vehicle passing the passing determination line from the right to the left corresponds to the monitoring vehicle being overtaken by the vehicle on the lane on the right side.

On the lane on the right side (opposite lane) of the monitoring lane, the vehicle passing the passing determination line from the left to the right corresponds to the monitoring vehicle passing the oncoming vehicle on the lane on the right side.

The video analysis unit 130 stores the counted value, together a time (start time of the unit time period, for example), and an average speed of the monitoring vehicle in a unit time period, for each frame image during a unit time period (for example, 10 seconds), into the data storage unit 150. The video analysis unit 130 may additionally store the location information of the monitoring vehicle at the corresponding time into the data storage unit 150.

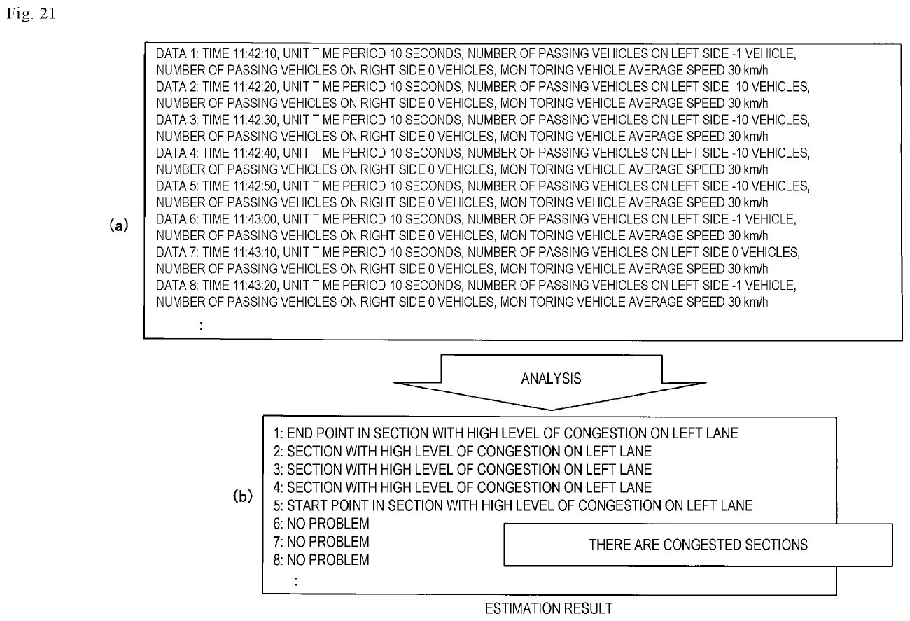

An example of data stored by the video analysis unit 130 into the data storage unit 150 in the case of Example 1 illustrated in FIG. 2 (in the case where the monitoring vehicle traveling on the center lane overtakes the vehicle on the left lane), is illustrated in FIG. 21(a).

In FIG. 21(a), data 1 indicates that the number of vehicles passing the passing determination line from the right to the left on the lane on the left side of the monitoring lane during 10 seconds from time 11:42:10 is one, indicates that the number of vehicles passing the passing determination line on the lane on the right side of the monitoring lane is zero, and indicates that the average speed of the monitoring vehicle during 10 seconds is 30 km/h.

Data 2 indicates that the number of vehicles passing the passing determination line from the right to the left on the lane on the left side of the monitoring lane during 10 seconds from time 11:42:20 is 10, indicates that the number of vehicles passing the passing determination line on the lane on the right side of the monitoring lane is zero, and indicates that the average speed of the monitoring vehicle during 10 seconds is 30 km/h. The same applies to the data below.

S103: Congestion Level Estimation, S104: Output

In S103, the congestion-level estimation unit 140 estimates, based on the data stored into the data storage unit 150 by the video processing unit 130 in S102, the level of congestion on the subject lane.

For example, the congestion-level estimation unit 140 estimates, based on the following rule, whether the level of congestion on the subject lane is high for each data for a unit time period (for example, 10 seconds). In other words, “the level of congestion is high” is “there is traffic congestion”. Each threshold value described below may be determined by, for example, an experiment and the like.

In the following rule, for the “number of passing vehicles” (the number of passing vehicles per unit time period), the number of vehicles passing in a direction in which the monitoring vehicle overtakes, and the number of vehicles passing in a direction in which the monitoring vehicle is overtaken are separately focused.

Firstly, rules (1-1) to (1-6) will be described. It is defined that the “number of passing vehicles” in (1-1) to (1-6) is the number of vehicles passing in a direction in which the monitoring vehicle overtakes, that is, the number of vehicles overtaken by the monitoring vehicle.

VTH1 and VTH2 are each threshold values with respect to a speed V, and NTH1, NTH2, and NTH3 are each threshold values with respect to the number of passing vehicles. It is assumed that 0<VTH1<VTH2 and 0<NTH2<NTH1<NTH3 are satisfied.

The following rules are in accordance with analysis that when the monitoring vehicle runs slowly, even if the number of vehicles overtaken by the monitoring vehicle is small, if the monitoring vehicle overtakes a few vehicles, it is possible to determine that there is traffic congestion on the subject lane, and when the monitoring vehicle runs at a high speed, even if the monitoring vehicle overtakes some vehicles, it is not possible to say that there is traffic congestion on the subject lane, and thus, when the number of vehicles overtaken by the monitoring vehicle is large, it is determined that there is traffic congestion on the subject lane.

(1-1) If an average speed V of the monitoring vehicle is “VTH1<V≤VTH2” and the number N of passing vehicles on the subject lane is “NTH1≤N”, it is estimated that the level of congestion on the subject lane is high.

(1-2) If the average speed V of the monitoring vehicle is “VTH1<V≤VTH2” and the number N of passing vehicles on the subject lane is “NTH1>N”, it is estimated that the level of congestion on the subject lane is low (causes no problem).

(1-3) If the average speed V of the monitoring vehicle is “0<V≤VTH1” and the number N of passing vehicles on the subject lane is “NTH2<N”, it is estimated that the level of congestion on the subject lane is high. In this case, it may be estimated that the level of congestion on the monitoring lane is also high.

(1-4) If the average speed V of the monitoring vehicle is “0<V≤VTH1” and the number N of passing vehicles on the subject lane is “NTH2>N”, it is determined to be estimation NG. However, the level of congestion may be determined by acquiring other information. For example, if it is sensed from the video that a vehicle is present on the subject lane, it may be estimated that the level of congestion on the subject lane is high, and if it is sensed that there is no vehicle on the subject lane, it may be estimated that the level of congestion on the subject lane is low. In this case, it may be estimated that the level of congestion on the monitoring lane is also high.

(1-5) If the average speed V of the monitoring vehicle is “V>VTH2” and the number N of passing vehicles on the subject lane is “NTH3≤N”, it is estimated that the level of congestion on the subject lane is high.

(1-6) If the average speed V of the monitoring vehicle is “V>VTH2” and the number N of passing vehicles on the subject lane is “NTH3>N”, it is estimated that the level of congestion on the subject lane is low (causes no problem).

Next, rules (2-1) to (2-2) will be described. It is defined that the “number of passing vehicles” in (2-1) to (2-2) is the number of passing vehicles in a direction in which the monitoring vehicle is overtaken, that is, the number of vehicles overtaking the monitoring vehicle.

VTH3 is a threshold value for the speed V, and NTH4 is a threshold value for the number of passing vehicles.

The following rules are based on analysis that when the monitoring vehicle runs slowly, if there are many vehicles overtaking the monitoring vehicle, it is possible to determine that there is traffic congestion on the monitoring lane and there is no traffic congestion on the subject lane, and when the monitoring vehicle runs slowly, if the vehicle travels on the subject lane and the number of vehicles on the subject lane overtaking the monitoring vehicle is small, it is possible to determine that there is traffic congestion on both the monitoring lane and the subject lane. Otherwise, it is determined that there is no problem.

(2-1) If the average speed V of the monitoring vehicle is “0<V≤VTH3” and the number N of passing vehicles on the subject lane is “NTH4≤N”, it is estimated that the level of congestion on the monitoring lane is high and the level of congestion on the subject lane is low (causes no problem).

(2-2) If the average speed V of the monitoring vehicle is “0<V≤VTH3” and the number N of passing vehicles on the subject lane is “NTH4>N”, it is determined to be estimation NG. However, the level of congestion may be determined by acquiring other information. For example, if it is sensed from the video that a vehicle is present on the subject lane, it may be estimated that the level of congestion on the subject lane is high, and if it is sensed that there is no vehicle on the subject lane, it may be estimated that the level of congestion on the subject lane is low. In this case, it may be estimated that the level of congestion on the monitoring lane is also high.

Next, rules (3-1) to (3-2) will be described. The rules (3-1) to (3-2) are rules applied when the subject lane is a lane opposite to the monitoring lane. In this case, the “number of passing vehicles” is the number of oncoming vehicles on the subject lane passed by the monitoring vehicle.

VTH4 is a threshold value for the speed V, and NTH5 and NTH6 are threshold values for the number of passing vehicles. 0<NTH5<NTH6 is satisfied.

The following rules are based on analysis that if there is traffic congestion on the subject lane (opposite lane) and the speed of the monitoring vehicle is high, the monitoring vehicle passes a large number of oncoming vehicles, and even if the speed of the monitoring vehicle is low, the monitoring vehicle passes a relatively large number of oncoming vehicles. Otherwise, it is determined to be estimation NG (or no problem is determined).

(3-1) If the average speed V of the monitoring vehicle is “0<V≤VTH4” and the number N of passing vehicles on the subject lane is “NTH5≤N”, it is estimated that the level of congestion on the subject lane is high.

(3-2) If the average speed V of the monitoring vehicle is “VTH4<V” and the number N of passing vehicles on the subject lane is “NTH6≤N”, it is estimated that the level of congestion on the subject lane is high.

In a more specific example, the congestion level estimation on the subject lane (left lane), based on data presented in FIG. 21(a) output from the video processing unit 130, will be described. As described above, FIG. 21(a) presents the data in the case where the monitoring vehicle overtakes the vehicle on the left lane.

Here, it is assumed that the average speed in a unit time period of the monitoring vehicle satisfies “VTH1<V≤TH2”, and the rule (1-1) and the rule (1-2) described above are applied. It is assumed that NTH1, that is, the threshold value of the number of passing vehicles, is 9.

Firstly, the congestion-level estimation unit 140 refers to data 1 to understand that the number N of passing vehicles on the left lane (the number of vehicles overtaken by the monitoring vehicle) is 1, that is, “NTH1>N” is satisfied, and thus, estimates that the level of congestion on the left lane in this section (section of a road on which the monitoring vehicle travels in 10 seconds from time 11:42:10) is low. In other words, the “section” may be a “zone”.

Next, the congestion-level estimation unit 140 refers to the data 2 to understand that the number N of passing vehicles on the left lane (the number of vehicles overtaken by the monitoring vehicle) is 10, that is, “NTH1≤N” is satisfied, and thus, estimates that the level of congestion on the left lane in this section (section of a road on which the monitoring vehicle travels in 10 seconds from time 11:42:20) is high. The same applies to data 3 to 5.

The congestion-level estimation unit 140 refers to data 6 to understand that the number N of passing vehicles on the left lane (the number of vehicles overtaken by the monitoring vehicle) is 1, that is, “NTH1>N” is satisfied, and thus, estimates that the level of congestion on the left lane in this section (section of a road on which the monitoring vehicle travels in 10 seconds from time 11:43:00) is low. The same applies to data 7 and 8.

The congestion-level estimation unit 140 detects that the level of congestion is high from the data 2 after the data 1, this state continues to the data 5, and the level of congestion is low from the data 6. As a result, the congestion-level estimation unit 140 estimates that a point corresponding to the data 1 (point of the road on which the monitoring vehicle travels in 10 seconds from time 11:42:10) is an end (END) point of a section with the high level of congestion on the left lane (that is, an end point of the traffic congestion), and estimates that a point corresponding to the data 5 (point of the road on which the monitoring vehicle travels in 10 seconds from time 11:42:50) is a start (START) point of a section with the high level of congestion on the left lane (that is, a start point of the traffic congestion).

Based on the results described above, the congestion-level estimation unit 140 outputs an estimation result illustrated in FIG. 21(b). The output estimation result is stored in the data storage unit 150.

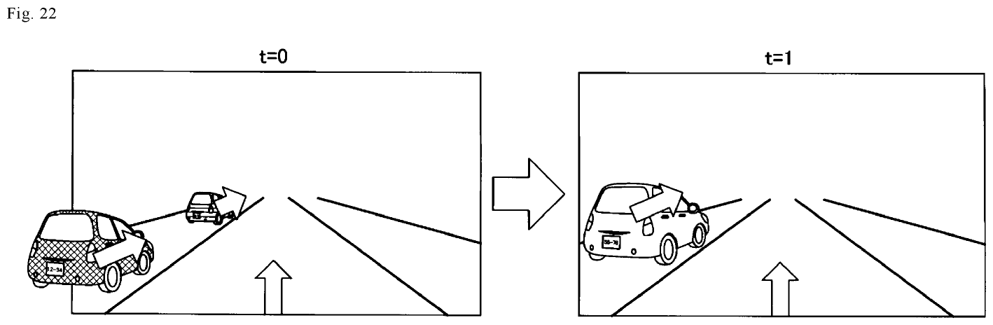

Next, as illustrated in FIG. 22, an estimation example in a case where the monitoring vehicle is overtaken by a vehicle on the left lane under a circumstance where the monitoring vehicle travels smoothly will be described.

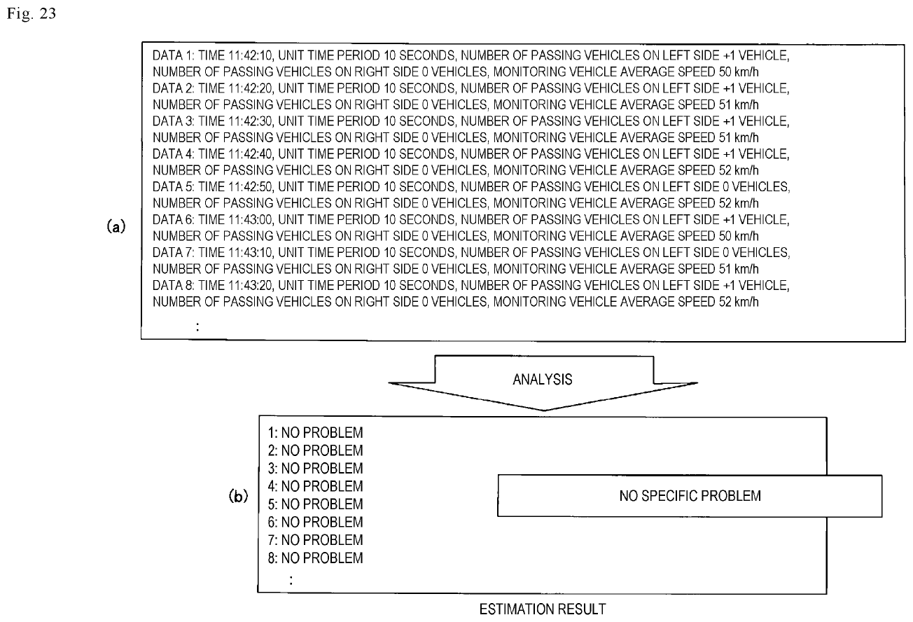

In this case, the video analysis unit 130 stores data illustrated in FIG. 23(a) in the data storage unit 150, for example. The congestion-level estimation unit 140 estimates that any data is not problematic, based on the rule applied when the monitoring vehicle is overtaken, and outputs an estimation result illustrated in FIG. 23 (b).

The congestion-level estimation unit 140 may refer to the map information and the like to further estimate a cause of the congestion (traffic congestion). The congestion cause estimation processing will be described below. The map information and the like may be stored in the data storage unit 150 and may be referred to by accessing a server on the Internet.

The congestion-level estimation unit 140 finally stores, as the estimation result, data as shown below, into the data storage unit 150. The estimation result is read by the output unit 160 from the data storage unit 150, based on a request from a user, for example, to be output to outside.

Data 1: national road No. 1, Start point (latitude xx1, longitude yy1), End point (latitude xx2, longitude yy2), cause (entrance of a commercial facility parking place), from time 11:42:10 to time 11:42:50, the number of passing vehicles on the left side−21 vehicles, the number of passing vehicles on the right side 0 vehicles, and monitoring vehicle average speed 51 km/h

Data 2: prefectural road No. GG, Start point (latitude xx3, longitude yy3), End point (latitude xx4, longitude yy4), cause (sag part), from time 11:44:50 to time 11:45:00, the number of passing vehicles on the left side 0 vehicles, the number of passing vehicles on the right side 0 vehicles, monitoring vehicle average speed 11 km/h

Example of Estimation of Cause of Congestion Next, an example of estimation of the cause of the congestion executed by the congestion-level estimation unit 140 will be described. The congestion-level estimation unit 140 estimates the cause of the congestion according to the following procedures S1 to S4, and if the road on which the monitoring vehicle travels is an expressway, the processing may proceed to S3 without performing S1 and S2.

S1

In S1, if there is a traffic signal unit around a start point of traffic congestion, it is estimated that the cause of the traffic congestion is waiting for traffic light to change. More particularly, in sensing, in the above processing, that the level of congestion in a certain section on a subject lane along the same travel direction as the travel direction of the monitoring lane is high (there is traffic congestion), the congestion-level estimation unit 140 determines whether there is a traffic signal unit within a predetermined range in a travel direction starting from a Start point in the section with a high level of congestion by searching map information (which may include a road network database, a traffic signal unit database, and the like).

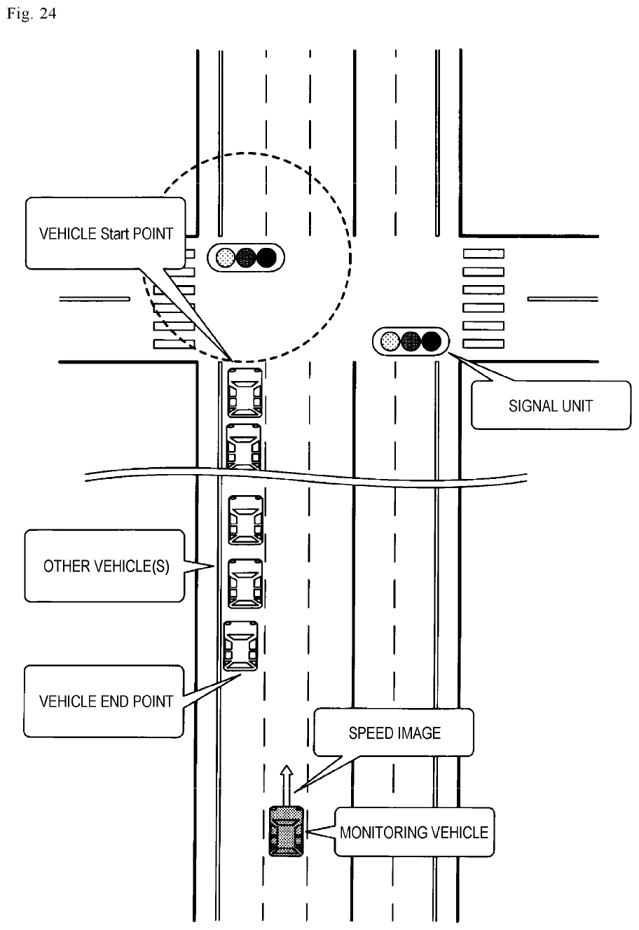

The predetermined range described above may, for example, be a range of a circle having N meters in diameter tangent to the Start point in the section with a high level of congestion, as illustrated in FIG. 24. N may be, for example, twice as long as the width of the road.

If a traffic signal unit is detected within the predetermined range described above, the circumstance illustrated in FIG. 24 applies, and thus, the congestion estimation unit 140 estimates that the “waiting for traffic light to change” is the cause of the high level of congestion.

S2

In S2, if it is sensed that there is a commercial facility or a parking place of the commercial facility around the start point of the traffic congestion, it is estimated that the cause of the traffic congestion is waiting for entry to the commercial facility. More details will be provided below.

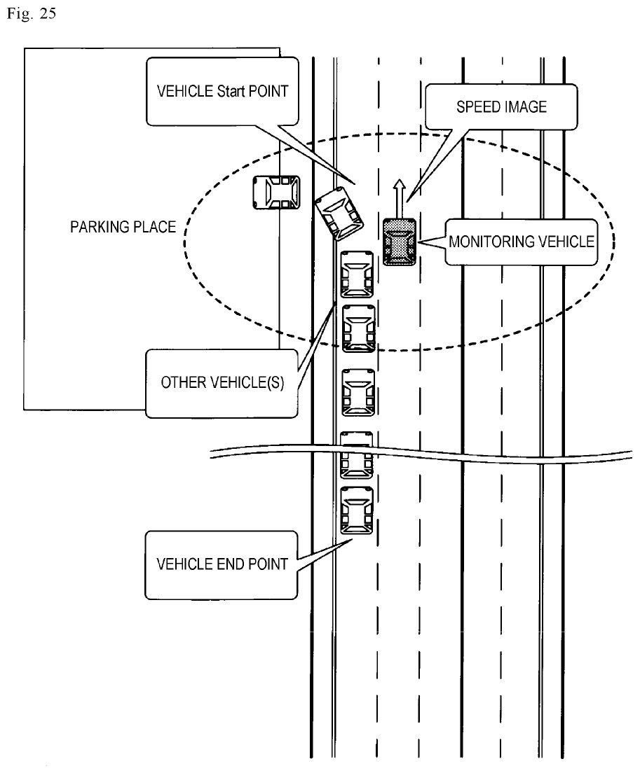

In S1, if no traffic signal unit is present within a predetermined range, the congestion-level estimation unit 140 searches a facility within a circle having a radius of M meters from the Start point in the section with a high level of congestion (or a position of the monitoring vehicle at a data time at which the Start point is detected) from the map information and the like. Note that as illustrated in FIG. 25, for example, the range to be searched may be an ellipse longer in a lateral direction with respect to the travel direction with the position of the monitoring vehicle at a time of the Start point being centered in the ellipse. A longer radius of a major axis of the ellipse may be M meters. M may be, for example, “½ the length of the road width+depth length of a general facility (width of a facility along the road, the width being perpendicular to the road)”.

If, as a result of the above search, the commercial facility or the parking place of the facility is detected, the congestion-level estimation unit 140 estimates that the level of congestion is high due to the vehicle on the subject lane waiting for entry to the facility. FIG. 25 illustrates an example of such a circumstance.

S3

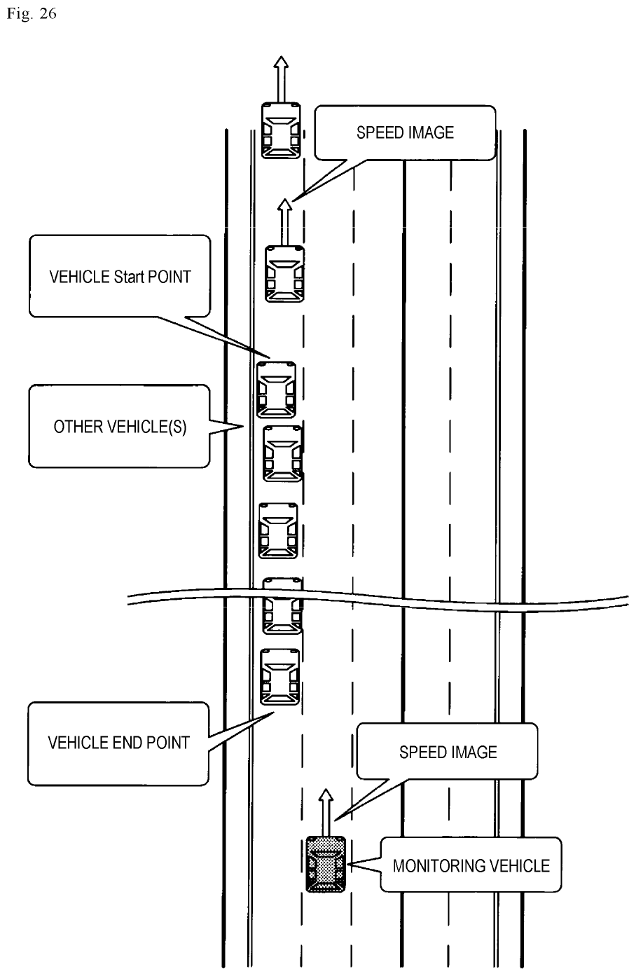

In neither above case applies, the congestion-level estimation unit 140 acquires altitudes (or heights) of a section with a high level of congestion (section A), a section forward of the section with a high level of congestion (section B), and a section rearward of the section with a high level of congestion (section C), on a road on which the monitoring vehicle travels, from the map information (dynamic map (altitude digital map) and the like). If values of section A=0 m, section B=5 m, and section C=5 m, for example, are obtained for an altitude, the congestion-level estimation unit 140 determines that the section A is a sag part (a recess changing from a downhill to an uphill), and estimates that the cause of the high level of congestion is because the vehicle passes the sag part. An example of a circumstance of a high level of congestion resulting from the sag part is illustrated in FIG. 26.

S4

If neither of S1 to S3 applies, the congestion-level estimation unit 140 estimates that the cause of the high level of congestion is “occurrence of an accident”. That is, the congestion-level estimation unit 140 estimates that traffic congestion due to an accident occurs. Note that “if neither of S1 to S3 applies, and if it is possible to acquire accident information around the section with a high level of congestion from traffic accident occurrence map information and the like”, the congestion-level estimation unit 140 may estimate the cause of a high level of congestion may be estimated to be the “occurrence of an accident”.

Thus, S1 to S4 are described.

Note that the congestion-level estimation unit 140 may analyze video captured from a location estimated to be the Start point of the traffic congestion to determine whether a traffic signal unit is captured in the video, whether a sign indicating a name of a parking lot or a commercial facility is captured, and whether a vehicle involved in an accident or an obstacle is captured, for example, to implement S1 and S2.

If it is not possible to estimate the cause by the analysis based on the Start point of the traffic congestion in S1 to S3, the cause may be estimated by implementing a similar analysis to those in S1 to S3 at a location from a point immediately after the Start point to the End point (including the End point).

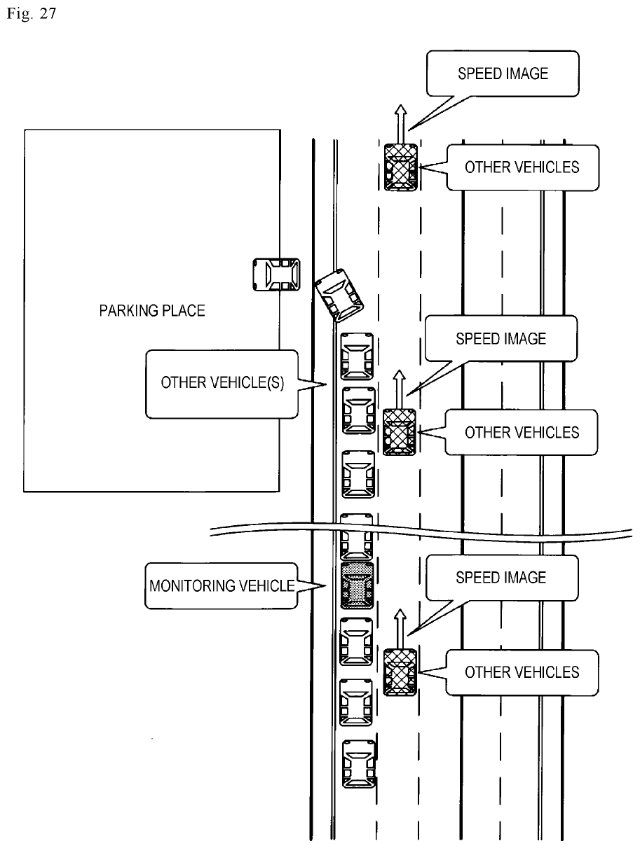

Note that in a case where it is estimated that the level of congestion on the monitoring lane is high and the level of congestion on the subject lane is low, as in a case where the above rule 2-1 applies, if a facility around a position of the monitoring vehicle at a time when a level of congestion is high is searched from the map information and the like, and as a result of the search, a large-scale commercial facility or a parking place of such a facility is detected, the congestion-level estimation unit 140 may estimate that the level of congestion on the monitoring lane is high due to the vehicle on the monitoring lane waiting for entry to such a facility. An example of such a circumstance is illustrated in FIG. 27.

Hardware Configuration Example

The congestion-level estimation apparatus 200 in the present embodiment can be achieved by causing a computer, for example, to execute a program describing contents of the processing described in the present embodiment. Further, the “computer” may be a physical machine or a virtual machine on cloud. In a case where a virtual machine is used, “hardware” to be described here is virtual hardware.

The above program can be stored or distributed with the program recorded on a computer readable recording medium (such as a portable memory). In addition, the above program can also be provided through a network such as the Internet or e-mail.

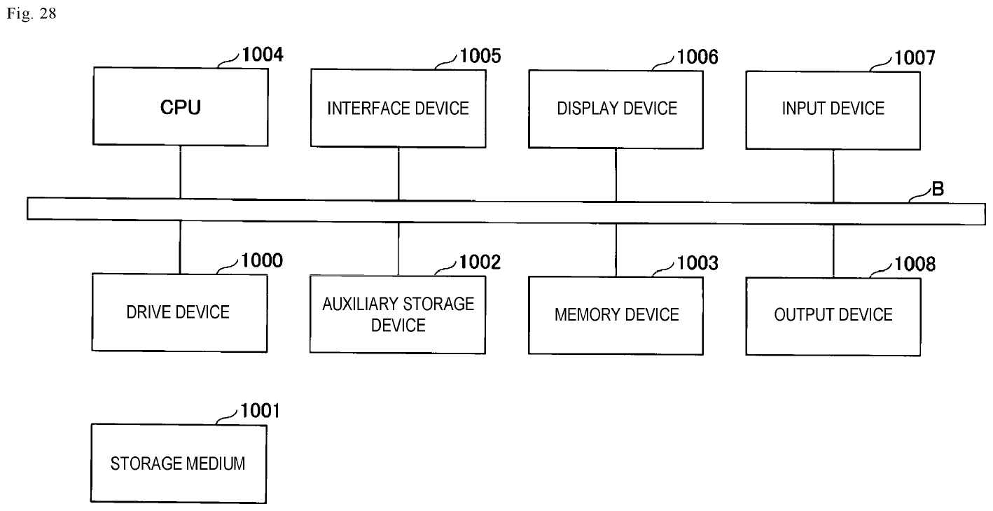

FIG. 28 is a diagram illustrating a hardware configuration example of the aforementioned computer. The computer in FIG. 28 includes a drive device 1000, an auxiliary storage device 1002, a memory device 1003, a CPU 1004, an interface device 1005, a display device 1006, an input device 1007, and the like which are connected to each other through a bus BS. Note that the computer may include a graphics processing unit (GPU) instead of or in addition to the CPU 1004.

A program for implementing processing in the computer is provided by means of a recording medium 1001 such as a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001, and may be downloaded from another computer through a network. The auxiliary storage device 1002 stores the installed program, and stores necessary files, data, and the like.

In response to an activation instruction of the program, the memory device 1003 reads out the program from the auxiliary storage device 1002 and stores the program. The CPU 1004 (or a GPU or the CPU 1004 and the GPU) implements the functions related to the apparatus in accordance with the program stored in the memory device 1003. The interface device 1005 is used as an interface for connection to a network. The display device 1006 displays a graphical user interface (GUI) or the like based on the program. The input device 1007 includes a keyboard, a mouse, a button, a touch panel, and the like, and is used for inputting various operation instructions. The output device 1008 outputs a calculation result.

### Effects of Embodiments

Thus, as described above, with the technology according to the present embodiment, it is possible to estimate a wide range of a state related to congestion of vehicles traveling on a road, and for example, it is also possible to estimate a head or a tail of traffic congestion or a cause of the traffic congestion (including waiting for entry to a parking place of a commercial facility).

### Conclusion of Embodiments

The present specification describes at least a state estimation method, a state estimation apparatus, and a program described in each of the following clauses.

### Clause 1

A state estimation method executed by a state estimation apparatus for estimating a state related to congestion on a subject lane, the method including:
acquiring a state related to congestion of a monitoring vehicle traveling on a non-subject lane;
counting a number of vehicles traveling on the subject lane, the vehicles being overtaken by the monitoring vehicle or being oncoming vehicles passed by the monitoring vehicle; and
estimating the state related to the congestion on the subject lane in accordance with the state related to the congestion of the monitoring vehicle and the number of the vehicles, wherein in the estimating, if the number of the vehicles is equal to or greater than a threshold value according to the state related to the congestion of the monitoring vehicle, the state related to the congestion on the subject lane is estimated to be traffic congestion.

### Clause 2

The state estimation method according to Clause 1, wherein in the estimating, the threshold value in a case in which the state related to the congestion of the monitoring vehicle is estimated to be traffic congestion is smaller than a threshold value in a case in which the state related to the congestion of the monitoring vehicle is estimated to be non-traffic congestion.

### Clause 3

The state estimation method according to Clause 1, wherein the state related to the congestion of the monitoring vehicle is determined in accordance with a speed of the monitoring vehicle.

### Clause 4

The state estimation method according to Clause 3, wherein in the estimating, the threshold value in a case in which the speed of the monitoring vehicle is a first value is smaller than the threshold value in a case in which the speed of the monitoring vehicle is a second value larger than the first value.

### Clause 5

The state estimation method according to any one of Clauses 1 to 4, wherein in the counting, the counting is performed by detecting that a vehicle on the subject lane passes a predetermined position on video captured by a camera mounted in the monitoring vehicle.

### Clause 6

The state estimation method according to any one of Clauses 1 to 5, wherein in the estimating, in a case in which the state related to the congestion on the subject lane is estimated to be traffic congestion, a start point and an end point of the traffic congestion are estimated in accordance with the number of vehicles overtaken by the monitoring vehicle per unit time period obtained in the counting.

### Clause 7

The state estimation method according to Clause 6, wherein in the estimating, upon sensing that a traffic signal unit exists around the start point of the traffic congestion, estimating that a cause of the traffic congestion is waiting for traffic light to change.

### Clause 8

The state estimation method according to Clause 6 or 7, wherein in the estimating, upon sensing that a commercial facility or a parking place of the commercial facility exists around the start point of the traffic congestion, estimating that a cause of the traffic congestion is waiting for entry to the commercial facility.

### Clause 9

The state estimation method according to any one of Clauses 6 to 8, wherein in the estimating further includes: acquiring heights of a section with the traffic congestion, a section forward of the traffic congestion, and a section rearward of the traffic congestion are acquired, and upon sensing that the section with the traffic congestion is lower than either of the section forward of the traffic congestion or the section rearward of the traffic congestion, estimating that a cause of the traffic congestion is a sag part.

### Clause 10

A state estimation apparatus for estimating a state related to congestion on a subject lane, the state estimation apparatus including:
an acquisition unit configured to acquire a state related to congestion of a monitoring vehicle traveling on a non-subject lane;
a count unit configured to count a number of vehicles traveling on the subject lane, the vehicles being overtaken by the monitoring vehicle or being oncoming vehicles passed by the monitoring vehicle; and
an estimation unit configured to estimate the state related to the congestion on the subject lane in accordance with the state related to the congestion of the monitoring vehicle and the number of the vehicles,
wherein the estimation unit estimates, in a case in which the number of the vehicles is equal to or greater than a threshold value according to the state related to the congestion of the monitoring vehicle, that the state related to the congestion on the subject lane is traffic congestion.

### Clause 11

A program for causing a computer to execute the processing in the state estimation method according to any one of Clauses 1 to 9.

Although the present embodiment has been described above, the present invention is not limited to such specific embodiments, and can be modified and changed variously without departing from the scope of the present invention described in the appended claims.

### REFERENCE SIGNS LIST

100 Congestion-level estimation system
110 Peripheral state acquisition unit
120 Monitoring vehicle state acquisition unit
130 Video analysis unit
140 Congestion-level estimation unit
150 Data storage unit
160 Output unit
170 Acquired information storage unit
200 Congestion-level estimation apparatus
1000 Drive device
1001 Recording medium
1002 Auxiliary storage device
1003 Memory device
1004 CPU
1005 Interface device
1006 Display device
1007 Input device
1008 Output device

1. A state estimation method executed by a state estimation apparatus including a processor and a memory storing program instructions that cause the processor to configured to estimate a state related to congestion on a subject lane, the method comprising:
acquiring a state related to congestion of a monitoring vehicle traveling on a non-subject lane;
counting a number of vehicles traveling on the subject lane, the vehicle being overtaken by the monitoring vehicle or being an oncoming vehicle passed by the monitoring vehicle; and
estimating the state related to the congestion on the subject lane in accordance with the state related to the congestion of the monitoring vehicle and the number of the vehicles,
wherein in the estimating, in a case in which the number of the vehicles is equal to or greater than a threshold value according to the state related to the congestion of the monitoring vehicle, the state related to the congestion on the subject lane is estimated to be traffic congestion.

2. The state estimation method according to claim 1, wherein in the estimating, the threshold value in a case in which the state related to the congestion of the monitoring vehicle is estimated to be traffic congestion is smaller than a threshold value in a case in which the state related to the congestion of the monitoring vehicle is estimated to be non-traffic congestion.

3. The state estimation method according to claim 1, wherein the state related to the congestion of the monitoring vehicle is determined in accordance with a speed of the monitoring vehicle.

4. The state estimation method according to claim 3, wherein in the estimating, the threshold value in a case in which the speed of the monitoring vehicle is a first value is smaller than the threshold value in a case in which the speed of the monitoring vehicle is a second value larger than the first value.

5. The state estimation method according to claim 1, wherein in the counting, the counting is performed by detecting that a vehicle on the subject lane passes a predetermined position on video captured by a camera provided in the monitoring vehicle.

6. The state estimation method according to claim 1, wherein in the estimating, in a case in which the state related to the congestion on the subject lane is estimated to be traffic congestion, a start point and an end point of the traffic congestion are estimated in accordance with a number of vehicles overtaken by the monitoring vehicle per unit time period obtained in the counting.

7. The state estimation method according to claim 6, wherein in the estimating, upon sensing that a traffic signal unit exists around the start point of the traffic congestion, estimating that a cause of the traffic congestion is waiting for traffic light to change.

8. The state estimation method according to claim 6, wherein in the estimating, upon sensing that a commercial facility or a parking place of the commercial facility exists around the start point of the traffic congestion, estimating that a cause of the traffic congestion is waiting for entry to the commercial facility.

9. The state estimation method according to claim 6, wherein in the estimating further includes:
acquiring a height of a section with the traffic congestion, a height of a section forward of the traffic congestion, and a height of a section rearward of the traffic congestion are acquired; and
upon sensing that the section with the traffic congestion is lower than either of the section forward of the traffic congestion or the section rearward of the traffic congestion, estimating that a cause of the traffic congestion is a sag part.

10. A state estimation apparatus for estimating a state related to congestion on a subject lane, the state estimation apparatus comprising:
a processor; and
a memory storing program instructions that cause the processor to:
acquire a state related to congestion of a monitoring vehicle traveling on a non-subject lane;
count a number of vehicles traveling on the subject lane, the vehicle being overtaken by the monitoring vehicle or being an oncoming vehicle passed by the monitoring vehicle; and
estimate the state related to the congestion on the subject lane in accordance with the state related to the congestion of the monitoring vehicle and the number of the vehicles,
wherein in a case in which the number of the vehicles is equal to or greater than a threshold value according to the state related to the congestion of the monitoring vehicle, the processor estimates that the state related to the congestion on the subject lane is traffic congestion.

11. A non-transitory computer-readable storage medium that stores therein a program for causing a computer to execute processing in the state estimation method according to claim 1.
